(19) United States
(12) Patent Application Publication
(10) Pub. No.: US 2011/0255178 A1
(43) Pub. Date: Oct. 20, 2011

(54) LENS FOR OPTICAL PICK-UP AND OPTICAL PICK-UP FOR OPTICAL DISC DRIVE

(75) Inventors: Shungo HANASHIRO, Kanagawa (JP); Akira IWABUCHI, Saitama (JP)

(73) Assignee: HOYA CORPORATION, Tokyo (JP)

(21) Appl. No.: 13/081,872

(22) Filed: Apr. 7, 2011

(30) Foreign Application Priority Data
Apr. 15, 2010 (JP) 2010-093710

(51) Int. Cl. G02B 3/02

(52) U.S. Cl. 359/719

(57) ABSTRACT

A lens for an optical pick-up formed by injection molding, the lens including a lens body having a first surface on an optical disc side and a second surface on a light source side, and a flange part formed to protrude from a periphery of the lens body outward in a radial direction of the lens body, and wherein a part of the flange part has been cut off along a cylindrical outer circumferential surface of the flange part to remove a gate part of the lens, and when D denotes a cutting depth of the flange part, R denotes a radius of the lens and W_{G} denotes a width of the gate part, the lens satisfies a condition:

$$D < R - \sqrt{{R}^{2} - {( \frac{{W}_{G}}{2} )}^{2}} .$$

### BACKGROUND OF THE INVENTION

The present invention relates to a lens for an optical pick-up and an optical pick-up for an optical disc drive employing the lens.

An optical disc drive which reads information from an optical disc, such as CD or DVD, has an optical pick-up. The optical pick-up includes a laser source and a lens which converges a laser emitted by the laser source onto the optical disc.

In general, a lens employed in an optical pick-up is made of resin. That is, the lens is a resin product formed by injection molding. Therefore, it is necessary to remove a gate part from the molded lens. Japanese Patent Provisional Publication No. 2009-181033A (hereafter, referred to as JP2009-181033A) discloses an example of a conventional lens from which a gate part has removed. JP2009-181033A discloses also a method for removing a gate part from a lens. FIG. 4A is a top view of a conventional lens 201, and FIG. 4B is a cross section of the lens 201 viewed along a line A-A in FIG. 4A. In the following, a direction of an optical axis of a lens is defined as an up-and-down direction, and a direction pointing to an optical disc side in the state where the lens 201 is installed on an optical pick-up is defined as an upward direction, and a direction pointing to a laser source side in the state where the lens 201 is installed on the optical pick-up is defined as a downward direction.

The lens 201 includes a lens body having an upper surface 211 (on an optical disc side) and a lower surface 212 (on a laser source side), and a flange part 220 formed to protrude from a periphery of the lens body. At an edge part of a lower surface 221 of the flange part 220, an installation surface 221a is formed to be recessed upward (i.e., to the optical disc side) with respect to the other part of the lower surface 221.

A gate part g of the lens 201 is formed to extend from an outer circumferential surface 222 of the flange part 220 in a radially outward direction. The gate part g is cut off by moving an endmill in the portion of the gate part g along a direction perpendicular to both of a radial direction of the lens 201 (i.e., a direction pointing from the gate part g to the center of the lens 201) and a direction of an optical axis of the lens 201 (i.e., a s-called D-cutting).

### SUMMARY OF THE INVENTION

In general, a lens is fixed to a holder of an optical pick-up with an adhesive. FIG. 5A is a top view of a general configuration of a holder 101 of an optical pick-up, and FIG. 5B is a cross section of the holder 101 in which the lens 201 is installed (a cross section viewed along a line B-B in FIG. 5A).

As shown in FIGS. 5A and 5B, the holder 101 is a plate-like member, and a circular through hole 111 for accommodating the lens 201 is formed in the holder 101 to extend from an upper surface 102a to a lower surface 102b. On a cylindrical inner surface of the through hole 111, three projections 121 are provided at intervals of 120 degrees with respect to a center axis ax. Each of the projections 121 is formed in a shape of a flange to protrude toward the center axis ax. On the upper surface 102a situated next to each projection 121, an adhesion catch 131 having a form of a letter “U” is provided. That is, three adhesion catches 131 are provided. The adhesion catches 131 are formed such that opened parts of the adhesion catches 131 face the projections 121, respectively. When the lens 201 is installed on the holder 101, the installation surface 221a of the lens 201 contacts upper surfaces of the projections 121 (see FIG. 5B).

In the state where the installation surface 221 a of the lens 201 is placed on the projections 121 of the holder 101, parts of the outer circumferential surface 222 of the flange part 220 face the adhesion catches 131, respectively. Therefore, at each adhesion catch 131, a recessed part sa (see FIG. 5B) is formed between an inner face 131a of the adhesion catch 131 and the outer circumferential surface 222 of the lens 201. By injecting an adhesion to each recessed part sa and by letting the adhesion harden, the lens 201 is fixed to the holder 101.

As described above, the lens 201 is held on the holder 101 in the state where the installation surface 221a of the lens 201 is placed on the projections 121 of the holder 101. However, as shown in FIGS. 4A and 4B, there is a possibility that, when the gate part g is cut off by D-cutting, a part of the installation surface 221a around the gate part g is also cut off largely together with the gate par g. The width W_{L} (see FIG. 5B) of the installation surface 221a and the width W_{P} (see FIG. 5A) of the projection 121 are formed to have minute values (each of which is a fraction of a radius of each surface of the lens 201) due to the downsizing of the lens 201. Therefore, if the lens 201 is placed on the holder 101 such that the gate part of the lens 201 is situated at one of the projections 201 of the holder 101, the holding state of the lens 201 by the projections 121 may become unstable. Furthermore since a part of the outer circumferential surface 222 of the flange part 220 of the lens 201 is cut off largely around the gate part, there is a possibility that, if the gate part of the lens 201 is situated near the projection 121, a gap is formed between the projection 121 and the flange part 220 and thereby the adhesion ad leaks from the gap.

The present invention is advantageous in that it provides a lens for an optical pick-up and an optical pick-up for an optical disc drive which are capable of stably holding a lens even if a gate part of the lens is situated at a projection of a holder, and capable of preventing an adhesion for fixing the lens from leaking.

According to an aspect of the invention, there is provided a lens for an optical pick-up formed by injection molding. The lens includes a lens body having a first surface on an optical disc side and a second surface on a light source side, and a flange part formed to protrude from a periphery of the lens body outward in a radial direction of the lens body. A part of the flange part has been cut off along a cylindrical outer circumferential surface of the flange part to remove a gate part of the lens. When D denotes a cutting depth of the flange part, R denotes a radius of the lens and W_{G} denotes a width of the gate part, the lens satisfies a condition:

$$D < R - \sqrt{{R}^{2} - {( \frac{{W}_{G}}{2} )}^{2}} .$$

With this configuration, the lens for an optical pick-up can be formed such that a gate part is completely removed while suppressing the cutting depth of the flange part to an extremely small. That is, even when the lens is attached to a holder such that a part of the lens where the gate part was provided is situated to the position of the projection of the holder, it is possible to place the flange part of the lens on the projections of the holder. Therefore, the lens can be stably held on the holder. Furthermore, even when the part of the where the gate part was provided is situated near to the projection of the holder, a gap is not formed between the flange part and each projection, and thereby it becomes possible to prevent the adhesion for fixing the lens to the holder from leaking from the gap.

Furthermore, since the amount of the cut part of the flange part is very small, the shifting distance of the gravity point of the lens due to cutoff of the gate part is also very small. Therefore, occurrence of vibration during activation of the optical pick-up due to unbalance of the lens can be prevented.

According to another aspect of the invention, there is provided an optical pick-up which includes the above described lens, and a holder on which the lens is held.

In at least one aspect, the holder may include a plate-like member in which a through hole is formed to accommodate the lens. In this case, projections are formed on an inner surface of the through hole to protrude from the inner surface toward a center axis of the through hole. The lens is held on the holder in a state where an installation surface of the lens contacts the projections of the holder.

In at least one aspect, adhesion catches each having a shape of a letter “U” may be formed respectively for the projections formed in the through hole. Each of the adhesion catches is formed adjacent to the projections on a peripheral side of the projections. The lens is fixed to the holder by injecting an adhesion into each of the adhesion catches.

### BRIEF DESCRIPTION OF THE ACCOMPANYING DRAWINGS

FIG. 1 is a top view of a lens according to an embodiment of the invention.

FIG. 2 is a side view of the lens viewed from a gate side.

FIG. 3 is a perspective view illustrating lenses before cut off from a runner.

FIG. 4A is a top view of a conventional lens, and FIG. 4B is a cross section viewed along a line A-A in FIG. 4A.

FIG. 5A is a top view of a holder of an optical pick-up, and FIG. 5B is a cross section of the holder in which a lens is installed, viewed along a line B-B in FIG. 5A.

### DETAILED DESCRIPTION OF THE EMBODIMENTS

Hereinafter, an embodiment according to the invention is described with reference to the accompanying drawings.

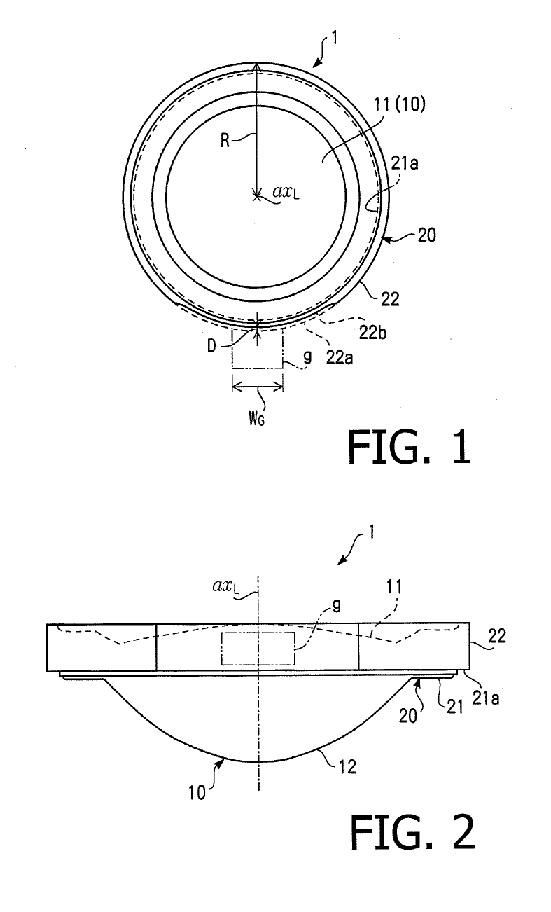

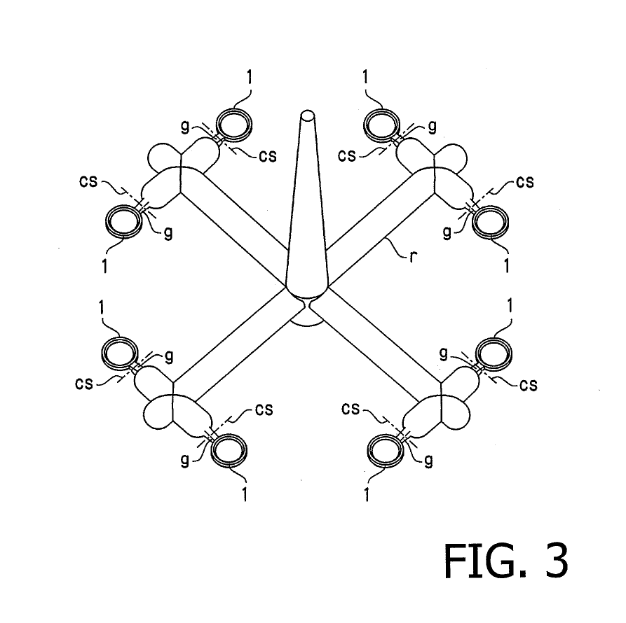

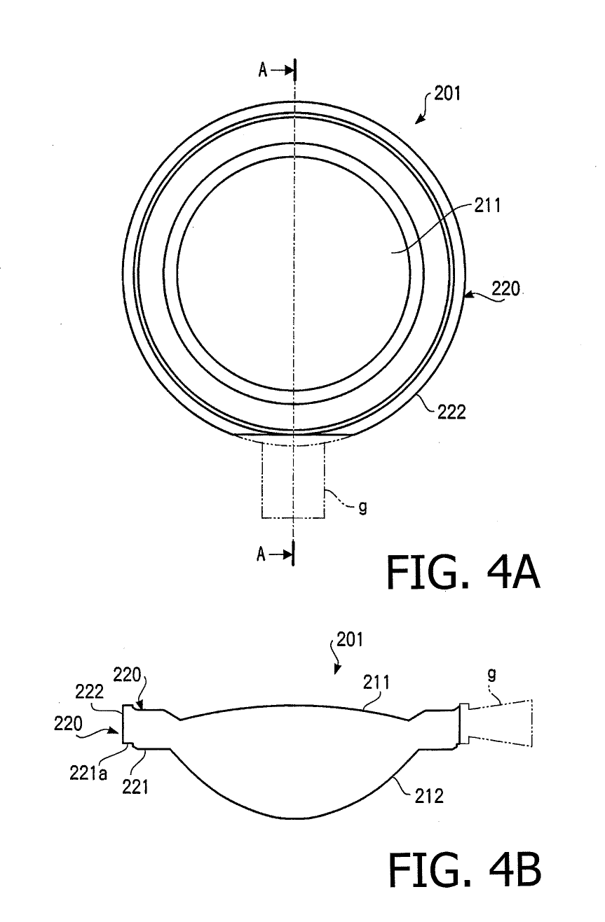

FIG. 1 is a top view of a lens 1 according to the embodiment of the invention. FIG. 2 is a side view of the lens 1 viewed from a gate side. FIG. 3 is a perspective view illustrating lenses 1 attached to a runner “r” (i.e., lenses 1 before cutoff).

As shown in FIG. 3, a plurality of lenses 1 (eight lenses 1 in FIG. 3) are formed in the state where the lenses 1 are integrated with the runner “r” via respective gate parts “g”. Each lens 1 removed from the runner “r” by cutting the gate part “g” along a cutoff surface cs. Therefore, in the state where the lens 1 has been cut off from the runner “r”, a part of the gate part “g” remains on the lens 1 (see a part indicated by a chain double-dashed line in FIGS. 1 and 2).

As shown in FIG. 2, the lens 1 includes a lens body 10 and a flange part 20. The lens body 10 has a first surface 11 (on the upper side in FIG. 2) and a second surface 12 (on the lower side in FIG. 2). The flange part 20 is formed to protrude from a periphery of the lens body 10 in a plane which is orthogonal to an optical axis ax_{L} of the lens body 10. It should be noted that, in the state where the lens 1 is installed in an optical pick-up, the first surface 11 is situated on an optical disc side, and the second surface 12 is situated on a light source side.

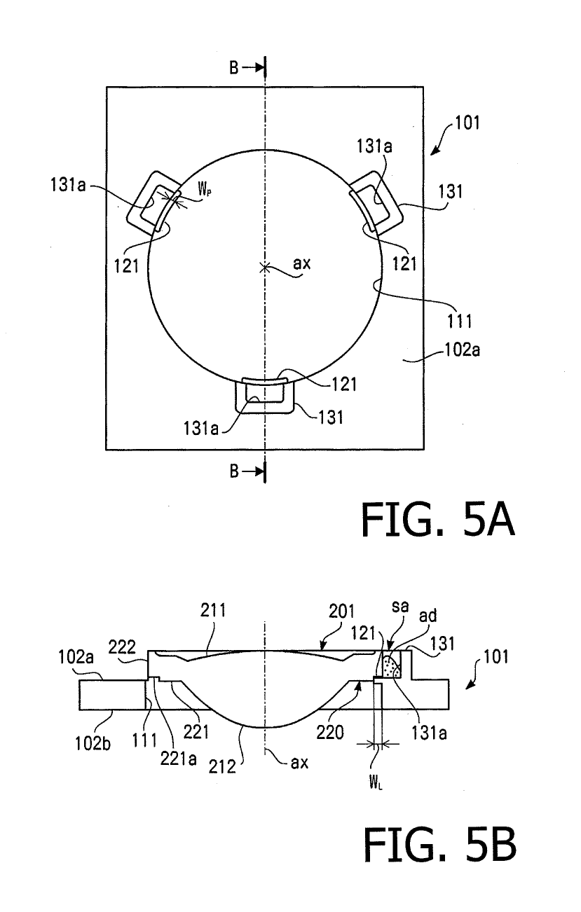

When the lens 1 is installed in the holder 101 of an optical pick-up shown in FIG. 5A, an installation surface 21a formed at a peripheral part of a surface 21 (which is a second surface 12 side of the flange part 20) is placed on the projections 121 of the holder 101.

As shown in FIGS. 1 and 2, the gate part “g” is formed to extend outward from the outer circumferential surface 22 of the flange part 20 in a radial direction of the flange part 20.

Since the gate part “g” could cause an installation failure of the lens 1 to the holder 101 of an optical pick-up, the gate part “g” needs to be removed. In this embodiment, the gate part “g” is removed from the lens 1 by endmill processing.

In this embodiment, as shown in FIGS. 1 and 2, the gate part “g” is removed by holding an endmill on a part of the outer circumferential surface 22 around the gate part “g” such that an axis direction of the endmill is oriented in the optical axis direction, and thereafter moving the rotating endmill along the outer circumferential surface 22 of the flange part 20 of the lens 1 to draw an arc. Furthermore, according to the embodiment, a cutting depth D of the flange part 20 (i.e., a distance between the outer circumferential surface 22a before cutting and the outer circumferential surface 22b after cutting) is defined to satisfy a condition:

$$D < R - \sqrt{{R}^{2} - {( \frac{{W}_{G}}{2} )}^{2}} \qquad ( 1 )$$

where R denotes a radius of the lens 1 (i.e., a distance between the optical axis ax_{L} and the outer circumferential surface 22 which is not cut off), and W_{G} denotes the width of the gate part “g”.

By cutting a part of the flange part 20 to satisfy the condition (1), it becomes possible to completely remove the gate part “g” from the lens 1 while suppressing the cutting depth D of the flange part 20 to be extremely small (i.e., without substantially decreasing the width of the installation surface 21a). That is, even when the lens 1 is attached to the holder 101 such that the part of the lens 1 at which the gate part “g” was provided is situated at the position of one of the Projections 121, it is possible to stably place the installation surface 21a of the lens 1 on the projections 121. Therefore, the lens 1 can be held stably by the projections 121. Even when the position of the lens 1 at which the gate part “g” was provided is situated near to the position of one of the projections 121, a gap is not formed between the flange part 20 of the lens 1 and the projection 121. As a result, it becomes possible to prevent the adhesion ad for fixing the lens 1 to the holder 101 from leaking through the gap.

Since the amount of the cut part of the flange part 20 is very small, the shifting distance of the gravity point of the lens 1 due to cutoff of the gate part “g” is also very small. Therefore, occurrence of vibration during activation of the optical pick-up due to unbalance of the lens 1 can be prevented.

Although the present invention has been described in considerable detail with reference to certain preferred embodiments thereof, other embodiments are possible.

This application claims priority of Japanese Patent Application No. P2010-093710, filed on Apr. 15, 2010. The entire subject matter of the application is incorporated herein by reference.

What is claimed is:

1. A lens for an optical pick-up formed by injection molding, comprising:
a lens body having a first surface on an optical disc side and a second surface on a light source side; and
a flange part formed to protrude from a periphery of the lens body outward in a radial direction of the lens body,
wherein:
a part of the flange part has been cut off along a cylindrical outer circumferential surface of the flange part to remove a gate part of the lens; and
when D denotes a cutting depth of the flange part, R denotes a radius of the lens and W_{G} denotes a width of the gate part, the lens satisfies a condition:
$$D < R - \sqrt{{R}^{2} - {( \frac{{W}_{G}}{2} )}^{2}} .$$

2. An optical pick-up, comprising:
a lens according to claim 1; and
a holder on which the lens is held.

3. The optical pick-up according to claim 2,
wherein:
the holder includes a plate-like member in which a through hole is formed to accommodate the lens;
projections are formed on an inner surface of the through hole to protrude from the inner surface toward a center axis of the through hole; and
the lens is held on the holder in a state where an installation surface of the lens contacts the projections of the holder.

4. The optical pick-up according to claim 3,
wherein:
adhesion catches each having a shape of a letter “U” are formed respectively for the projections formed in the through hole, each of the adhesion catches being formed adjacent to the projections on a peripheral side of the projections; and
the lens is fixed to the holder by injecting an adhesion into each of the adhesion catches.
